(19) United States
(12) Patent Application Publication
(10) Pub. No.: US 2018/0188913 A1
(43) Pub. Date: Jul. 5, 2018

(54) SYSTEM AND METHOD FOR DIGITAL TELEVISION OPERATION AND CONTROL - CONNECTION INTERFACE

(71) Applicants: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(72) Inventors: Sanjiv SIRPAL, Oakville (CA); Mohammed SELIM, Oakville (CA); Alexander DePaz, Burlington (CA); Salvador SOTO, Toronto (CA); Saulo Correia DOURADO, Oakville (CA); Robert MacArthur, Milton (CA); Dean BRITTO, Mississauga (CA)

(73) Assignees: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(21) Appl. No.: 15/396,288

(22) Filed: Dec. 30, 2016

(51) Int. Cl. G06F 3/0484; G06F 3/0488

(52) U.S. Cl. CPC G06F 3/0484; G06F 3/04883

(57) ABSTRACT

The present disclosure relates to digital television processes and systems. In one embodiment, a method of controlling a display device is disclosed, wherein the display device presents a graphical representation of a control interface, displays a machine readable graphical element to initiate a temporary connection between the display device and a peripheral device, identifies detection of the machine readable graphical element by the peripheral device, hosts a connection interface for control of the display device by the peripheral device, receives from the peripheral device through the connection interface, and updates a presentation format of the control interface to include the content.

### FIELD

The present disclosure relates to electronic devices and applications, and more particularly to display and content presentation devices.

### BACKGROUND

Recent television devices are designed and developed to provide application and network services in addition to traditional television functions for display of broadcasted content. With the addition of functionalities and components on television devices, there exists a need for control interfaces for applications and television components. In particular, there exists a need for programs and configurations that allow for features of the applications to be presented, accessed and customized on a digital television. While execution of an application and application interfaces exist for digital televisions, there exists a need for improved control of television features. It can be difficult for device manufactures to provide menu based configurations that fit all devices across different product markets. Moreover, there exists a desire for interfaces to be customizable. Conventional on-screen interfaces do not allow for customization. Moreover, the conventional interfaces require complex menus with distracting elements and can require extraneous actions for use. There is a desire for modified configurations to optimize control and experience of digital televisions.

### BRIEF SUMMARY OF THE EMBODIMENTS

Disclosed and claimed herein are methods, devices and systems for control of a digital television. One embodiment is directed to a method of controlling a display device. The method includes the display device presenting a graphical representation of a control interface, displaying a machine readable graphical element to initiate a temporary connection between the display device and a peripheral device, identifying detection of the machine readable graphical element by the peripheral device, hosting a connection interface for control of the display device by the peripheral device, receiving from the peripheral device through the connection interface, and updating a presentation format of the control interface to include the content.

In one embodiment, the display device presenting the graphical representation of the control interface includes presentation of a personal dashboard control interface.

In one embodiment, the display device displaying the machine readable graphical element includes display of a QR code.

In one embodiment, the display device identifying detection of the machine readable graphical element by the peripheral device includes receiving an indication from the peripheral device over a local network.

In one embodiment, the method includes hosting, by the display device or an application server communicatively coupled to the display device, instructions for executing the method, wherein receiving, by the display device, content from the peripheral device through the connection interface and updating, by the display device, the presentation format of the control interface to include the content includes controlling the display format of the display device through a web browser of the peripheral device and/or one or more settings of the control interface.

In one embodiment, the display device receiving content from the peripheral device through the connection interface includes synchronizing a text keyboard of the peripheral device with a text entry interface of the control interface of the display device.

In one embodiment, the display device receiving content from the peripheral device through the connection interface includes selectively positioning one or more tiles of the control interface associated with content or content sources.

In one embodiment, the display device identifying detection of the machine readable graphical element by the peripheral device is determined by identifying information of the peripheral device (e.g. a phone number, identity of a mobile device, a user account, a chip, near field communication, etc).

In one embodiment, the display device receiving content from the peripheral device through the connection interface includes accessing or retrieving an application package for execution of the method directly from the display device.

In one embodiment, a system is also disclosed for controlling a display device. The display device includes a display configured to present a control interface. The display device also includes a processor coupled to the display, the processor configured to present, by the display device, a graphical representation of a control interface; display, by the display device, a machine readable graphical element to initiate a temporary connection between the display device and a peripheral device; identify, by the display device, detection of the machine readable graphical element by the peripheral device; host, by the display device, a connection interface for control of the display device by the peripheral device; receive, by the display device, content from the peripheral device through the connection interface; and update, by the display device, a presentation format of the control interface to include the content.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a control interface of a display device according to one or more embodiments;

FIG. 2 depicts a simplified system diagram according to one or more embodiments;

FIG. 3 depicts a graphical representation of a digital television control interface according to one or more embodiments;

FIG. 4 depicts a graphical representation of digital television operation according to one or more embodiments;

FIG. 5 depicts an example remote control according to one or more embodiments;

FIG. 6 depicts a graphical representation of digital television operation according to one or more embodiments; and

FIG. 7 depicts a schematic overview of a method controlling a display device.

### DETAILED DESCRIPTION OF THE EXEMPLARY EMBODIMENTS

### Overview and Terminology

One aspect of the disclosure relates to controlling a display device. The method includes the display device presenting a graphical representation of a control interface, displaying a machine readable graphical element to initiate a temporary connection between the display device and a peripheral device, identifying detection of the machine readable graphical element by the peripheral device, hosting a connection interface for control of the display device by the peripheral device, receiving from the peripheral device through the connection interface, and updating a presentation format of the control interface to include the content.

In one embodiment, the display device presenting the graphical representation of the control interface includes presentation of a personal dashboard control interface. The display device displaying the machine readable graphical element can also include display of a QR code. The display device identifying detection of the machine readable graphical element by the peripheral device can include receiving an indication from the peripheral device over a local network.

In one embodiment, the method includes hosting, by the display device or an application server communicatively coupled to the display device, instructions for executing the method, wherein receiving, by the display device, content from the peripheral device through the connection interface and updating, by the display device, the presentation format of the control interface to include the content includes controlling the display format of the display device through a web browser of the peripheral device and/or one or more settings of the control interface.

In one embodiment, the display device receiving content from the peripheral device through the connection interface includes synchronizing a text keyboard of the peripheral device with a text entry interface of the control interface of the display device. In one embodiment, the display device receiving content from the peripheral device through the connection interface includes selectively positioning one or more tiles of the control interface associated with content or content sources, changing a channel of the display device, accessing additional content interfaces, and other operations of a television. In one embodiment, the display device identifying detection of the machine readable graphical element by the peripheral device is determined by identifying information of the peripheral device (e.g. a phone number, identity of a mobile device, a user account, a chip, near field communication, etc). In one embodiment, the display device receiving content from the peripheral device through the connection interface includes accessing or retrieving an application package for execution of the method directly from the display device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

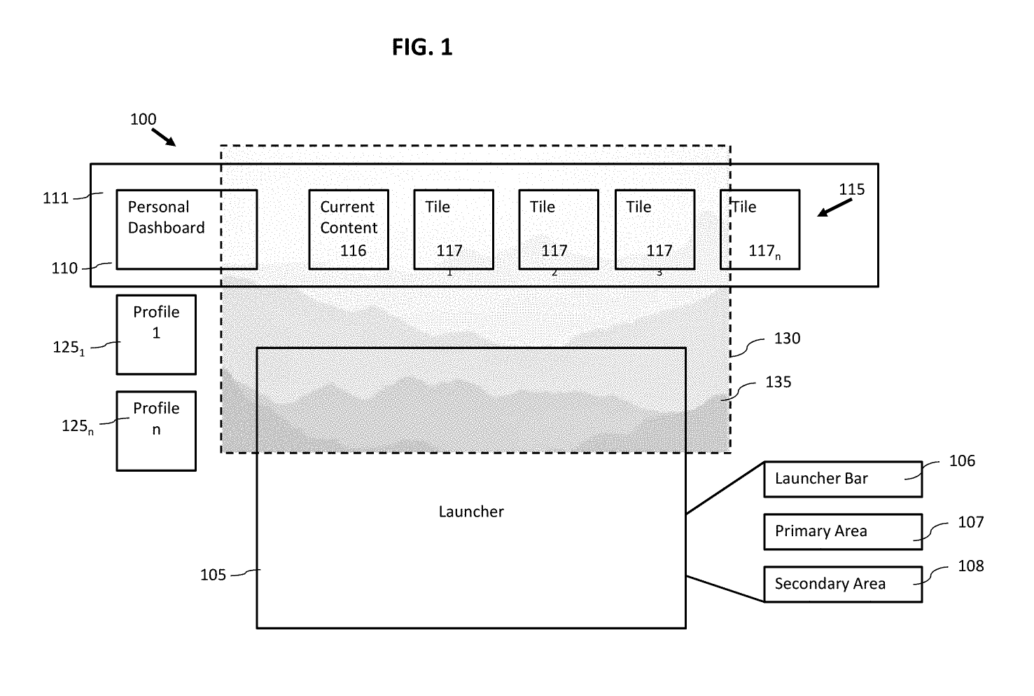

Referring now to the figures, FIG. 1 depicts a graphical representation of a control interface of a display device according to one or more embodiments. According to one embodiment, control interface 100 relates to a graphical user interface presented to control a display device, such as a digital television. According to one aspect of the disclosure, control interface 100 includes a plurality of components that each provide a plurality of functions and features for control and operation of a display device. In addition to providing separate components for particular interaction, control interface may also be configured to operate with a specific arrangement. According to one embodiment, presentation of each component of control interface 100 is presented based on a spatial arrangement model. According to one embodiment, the spatial arrangement model defines a relative position of components of control interface 100 to allow for directional navigation of the interface. By employing a spatial arrangement model, components of the control interface 100 allow for many features of the display device to be easily accessed and controlled. In addition to facilitating access, the spatial arrangement model provides a specific formatting to each view of control interface to emphasize elements for control.

According to one embodiment, components of control interface 100 include launcher component 105, dashboard component (e.g., personal dashboard) 110 and activity strip 115. According to another embodiment, a spatial arrangement model defines the location of each component of control interface 100 relative to a display screen. In an exemplary embodiment, launcher component 105 is oriented relative to a bottom portion of the display, dashboard component (e.g., personal dashboard) 110 is oriented relative to a left side of the display, and activity strip 115 is oriented relative a right side of the display. According to another embodiment, the display format of each component is defined by the spatial arrangement model such that each component may have an initial presentation characterized by a particular format, size, functionalities displayed, etc. Based on navigation commands relative to the control interface, the display device may update and rearrange the position and display format for each component of control interface 100.

Control interface 100 is shown in FIG. 1 relative to a display 130 and display content 135. According to one embodiment, the display format of control interface 100 can include presentation of some or all components of the control interface on display 130. Based on commands detected during presentation of the control interface 100, a display device may update the presentation format and elements of control interface 100 on display 130.

According to one embodiment, control interface 100 provides a mechanism for accessing multiple components of a display device. While the description of FIG. 1 discusses three components of control interface 100 (launcher component 105, dashboard component 110 and activity strip 115), it should be appreciated that additional components may be added to or included with control interface 100. As will be discussed herein, control interface 120 may be employed to control operation of digital television.

Activity bar includes plurality of tile elements 116 and 117₁₋ₙ. According to one embodiment, presentation of control interface 100 may be presented as an overlay to content 135 presented on display 130. The display device may freeze or continue presenting the display output of content 135 in a tile element 116 in activity bar 115. In certain embodiments, navigation away from current content tile 116 will pause or stop playback. Current content tile 116 allows for selection of the previously displayed content to return to presentation of the display. Current content tile 116 is presented based on the content displayed by the display device prior to display of control interface 100. Tile elements 117₁₋ₙ relate to activity feed based on current content. In one embodiment, tile elements 117₁₋ₙ relate to a single type of content, such as broadcast TV shows related current content 116 and/or based on viewing habits of an active profile. According to another embodiment tile elements 117₁₋ₙ may be a mix of content types, such as broadcast content, video on demand, applications, etc. In one embodiment, a display device may curate content and features to be included with activity bar as tile elements 117₁₋ₙ and present activity bar as a horizontal deck of elements in horizontal region 111. Horizontal region 111 allows for left and right directional commands to navigate to and within components of control interface 110.

Profiles 125₁₋ₙ relate to one user profiles stored by a display device for control interface 100. In one embodiment, profiles 125₁₋ₙ are utilized to determining display format of the personal dashboard component 110. According to another embodiment, one or more elements of launcher component 105 and activity strip 115 may be presented base on an active profile of profiles 125₁₋ₙ. When a profile has not been selected, an active profile may be the last selected or utilized user profile.

According to another embodiment, components of control interface 100 may be selected, navigated and updated based on user interactions with a display device and one or more inputs from a remote control. According to one embodiment, elements of control interface 100 are presented by display device 130, such as digital television, as part of control interface 120.

Presentation of control interface 100 may be in response to a command from remote control, such as selection of a home or menu key. According to another embodiment, control interface 100 may be displayed shortly after a power on of display device 130. According to another embodiment control interface 100 may be presented following presentation of a wake animation and prior to display of a sleep or shutdown animation.

From control interface 100, several features and functions of a display device may be provided by ordered combinations of display device operation and graphical elements presented by the display device.

### Launcher

According to one embodiment, launcher component 105 is configured to allow for a user to access content and control features of the display device. In one embodiment, launcher component includes a launcher bar 106, primary area 107 and secondary area 108. Launcher bar 106 may related to a plurality of tab elements arranged in a horizontal strip, wherein selection by moving a highlight element of the display device to a tab element will update the presentation elements of the launcher. By way of example, launcher bar 105 may include a tab for broadcast channels, video on demand and display device settings. Primary area 107 may include presentation of tile elements below the launcher bar 106. Tile elements of primary area 107 may be selected by the display device as the most relevant content of features associated with a selected tab element. Secondary area 108 may be presented below the primary area with additional tiles associated with content and/or display device function. Secondary area 108 may allow for additional selectable elements. According to one embodiment, the display format of launcher bar 106, primary area 107, and secondary area 108 may be based on the presentation status of the control interface. For example, launcher component may be presented initially with launcher bar 106, then commands to expand launcher component (e.g., a directional command) can result in display device updating the display output to include one or more tile elements of the primary area. Tile elements of the secondary area 108 may be presented based on additional navigation within the launcher component.

According to one embodiment, an initial format, such as a home screen presentation, of control interface 100 includes presentation of launcher bar, and a row of tile elements of the primary area. Based on a user input to select and/or navigate within launcher component 105, additional formats may be presented such as an increase in presentation footprint of the launcher to allow for secondary area 108 to include additional rows of tile elements. According to another embodiment, the primary area 107 and secondary area 108 of launcher component 105 may also include a first section for presentation of a most relevant tile element, and a second section for presentation of other tile elements along a horizontal display plane.

According to one embodiment, control interface 100 provides launcher component 105 as an overlay control interface to allow for presentation of content and control features based on selection of launcher tabs and navigation within the launcher component. In one embodiment, the configuration of launcher component 105 is a progression away from traditional desktop menus and allows for simple directional commands to access TV, network, applications, recommendations, personalized configurations, and recent content. According to another embodiment, launcher bar 106 of launcher component 105 includes a plurality of tab or tile elements, wherein each tab allows for a selection of a particular type of content, source of content, and/or control features of a display device. Based on the selection of a tab element of launch bar 106, launcher component may present multiple rows of content/element tiles and allows for scrolling to additional rows within a display window to provide and extended content region. In one embodiment, each row of content tiles may be navigated to based on vertical directional commands (e.g., up/down) and rows of content tiles may be navigated with horizontal directional commands (e.g., left/right). The presentation order of rows and even tiles in each row may be based on one or more of a selected user profile, content presented prior to display of control interface 100 and relevance determinations. In additional to content, such as video and programming information, tiles presented in launcher component 105 may relate to one or more of applications, settings, smart home applications, education/learning applications, gaming, etc.

### Launcher Search

According to one embodiment, control interface 100 may include a search functionality component including a graphical interface for searching content titles, applications and elements of launcher component 105. In one embodiment, the search functionality may be presented as a drop down (e.g., down sliding transition) interface from an intermediary presentation format of control interface 100. According to another embodiment, the search functionality can interact with other devices (e.g., mobile devices) with a display device hosting a network interface for entry of search queries. Features of the search functionality can include one or more of a text entry box, alpha numeric display, recent search listing and suggested search results.

### Personal Dashboard

According to one embodiment, control interface 100 includes dashboard component 110 to provide a user customizable control interface for a portion of the control features. In one embodiment, dashboard component 110 provides graphical elements for selecting and modifying display attributes and functionality of the dashboard. According to another embodiment, dashboard component can allow for a graphical selection of user profiles that can define features of control interface 100.

According to one embodiment, personal dashboard component 110 allows for presentation of a personalized control interface associated with a user profile. By way of example, display device is configured to allow a user to personalize the display format of the user interface to select display attributes such as a wallpaper, avatar, etc. In that fashion, dashboard component 110 allows for presentation of a personalized control interface. According to one embodiment, control interface 100 can allow for presentation of several user profiles 125₁₋ₙ. Selection of the profile may be performed during navigation to personal dashboard component 110 within control interface 100. According to one embodiment, the initial display presentation format of personal dashboard component 110 relates to a tile element, such as a screen capture of the personal dashboard. When an intermediate display configuration of control interface 100 is provided, the same tile representing personal dashboard component 110 may be reformatted. According to one embodiment, personal dashboard component 110 may be displayed adjacent to activity bar 115 in a horizontal region 111 of the display.

In one embodiment, dashboard component 110 provides a display interface to include notifications and access to applications which may be run by a display device. According to another embodiment, dashboard component 110 allows for personalization such as one or more of wake/sleep animations, screensavers, audio themes, badges and gaming. Dashboard component 110 allows for a customizable interface within the overall control interface 100 of a display device.

### Touch Interface

Presentation of elements within control interface can include one or more display formats and format changes. In certain embodiments, presentation of elements introduces similarities of touch commands to a display device operated from a distance without actual contact to the display. According to one embodiment, control interface 100 can update presentation of display elements such as tiles to gradually reveal content. According to one embodiment, control interface 100 can receive inputs based on a capacitive touch sensor with gradual display of elements, but also allowing for accidental touches. Capacitive interaction can provide a control feature with a level of touch control for a display device that is normally operated/viewed from a distance. Control interface 100 may be configured with an interaction to model tactile representation for interaction with elements based on a capacitive/interactive remote control. In one embodiment, interaction may include progressive disclosure of content, a multilayered preview into content and instant access to recommendation.

### Contextual Touch

According to one embodiment, elements of control interface 100 can support presentation of tile elements as overlay to content without presentation of the full control interface. By way of example, a display device may be configured to recognize a category or genre of actively displayed content and present a display of similar programs to avoid the need to access a display menu and searching of content.

### Instant Companion Application and Search

According to one embodiment, control interface 100 can allow for control of a display device by a mobile device and to allow for presentation of graphical display elements of control interface 100 to be displayed by a mobile device. In one embodiment, control interface 100 may host temporary access between a display device and another web enabled device. According to another embodiment, devices may be paired based on displayed elements that may be detected by the web enabled device. Thus, control interface 100 may be configured for pairing/connection with a user interface, such as a personalized user dashboard for display devices and search functions within the launcher control interface. According to certain embodiments, interaction of a mobile device with control 100 does not require a user to download a specific application to establishing the temporary network connection for interaction and control of a display device.

### Smart Sense Recommendations

According to one embodiment, control interface 100 can utilize one or more processes for populating content elements within launcher component 105. According to one embodiment, control interface 100 may be presented based on processes for tracking and identifying content for recommendation within the launcher component. For example, content tiles may be arranged in groupings such that groupings with the highest contextual relevance priority are arranged towards the top of launcher component 105.

Conversense

According to one embodiment, control interface 100 and elements of control interface 100 can be utilized by a display device to present a display configured tailored to startup of the display device with information and display elements having high relevance. In one embodiment, elements of the startup display may be selected and presented based on a recognized time of day, personal settings and history.

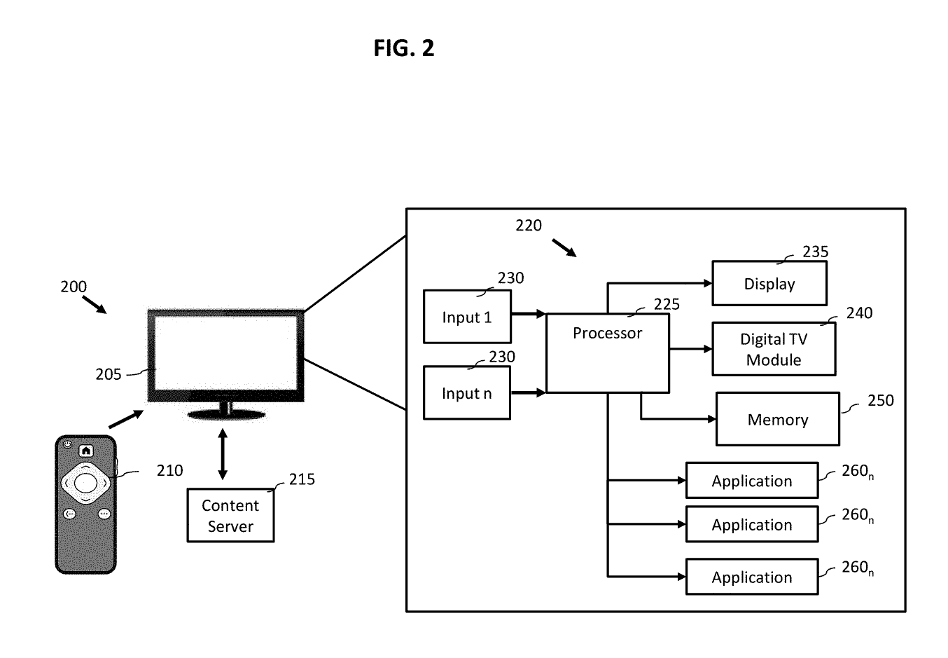

FIG. 2 depicts a simplified system diagram according to one or more embodiments. System 200 include display device 205 and remote control 210. Remote control 210 may be configured to provide commands for interaction with and control of display device 205 relative to a control interface (e.g., control interface 100) presented by display device 205. Content, applications and other network services may be provided to display device 205 by way of one or more content servers, such as content server 215.

Digital television 200 includes processor 225, inputs 230, display 235, digital TV module 240, memory 250, and applications 260₁₋ₙ. It should be appreciated that digital television 205 may include one or more additional components not shown in FIG. 2. Digital television 205 is configured to present a control interface as described herein.

Inputs 230 relate to physical inputs for receiving video/image content and/or network data for presentation of content on display 235. Digital TV module 240 includes decoder/converter elements to receive information and content from inputs 230 which is then formatted and output to processor 225 for presentation on display 235. Memory 250 may include ROM and RAM memory for operation of digital television 205 and processor 225.

Processor 225, in addition to controlling operation of a digital television, is configured to control presentation and operation of a control interface. According to one embodiment, processor 225 is configured to detect commands for presentation of a control interface for the digital television, present the control interface including an expanded tab element and a plurality of tab elements. Processor 225 may also detect second or additional commands for the control interface to select one of the plurality of tab elements and update presentation of the control interface in response to the commands.

### Exemplary Embodiments

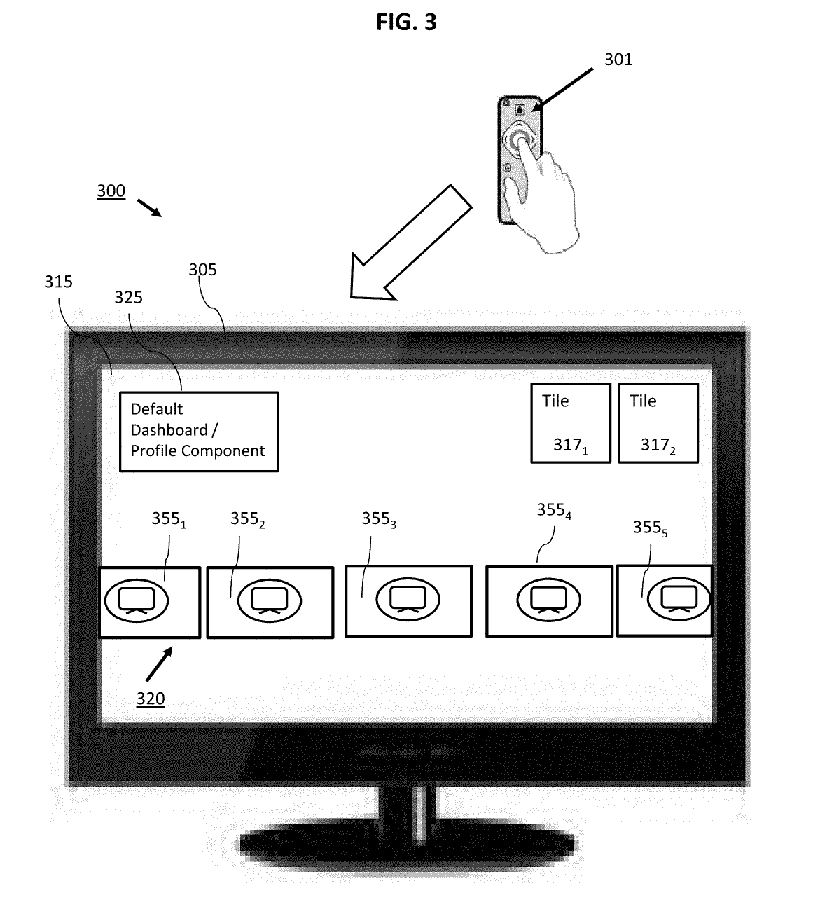

FIG. 3 depicts a graphical representation of a digital television control interface according to one or more embodiments. System 300 includes peripheral device (e.g., remote control) 301 and display device 305 configured to present control interface 320. According to one embodiment, control interface 320 is presented on display 305 and includes a default dashboard component 325 to provide a default user control interface for a portion of the control features associated with content presented on display 305. In one embodiment, dashboard component 325 provides default graphical elements 355ₙ for selecting and modifying display attributes and functionality of the dashboard, including content titles, current events, weather, news, and the like.

In one embodiment, control interface 320 provides a platform for notifications and access to applications and content to be presented which may be run by display device 305. Interface 320 may include an activity bar with a plurality of tile elements 355₁₋ₙ . Similar to interface 100 of FIG. 1, the display device 305 of FIG. 3 may freeze or continue presenting the display output of content of respective elements 355₁₋ₙ, if selected, in the same tile, another enlarged tile, or in overall display device 305. In certain embodiments, navigation away from current tile element 355₁₋ₙ will pause or stop playback. Elements 355₁₋ₙ allows for selection of the displayable content to be presented on display. Elements 355₁₋ₙ can relate to activity feed based on currently displayed content, a single type of content (e.g. broadcast TV shows related to currently displayed content) and/or based on viewing habits of the default profile associated with display device 305. According to another embodiment tile elements 355₁₋ₙ can may be a mix of content types, such as broadcast content, video on demand, applications, etc. In one embodiment, a display device may curate content and features to be included with activity bar as tile elements 355₁₋ₙ , can and present activity bar as a horizontal deck of elements 317₁₋ₙ.

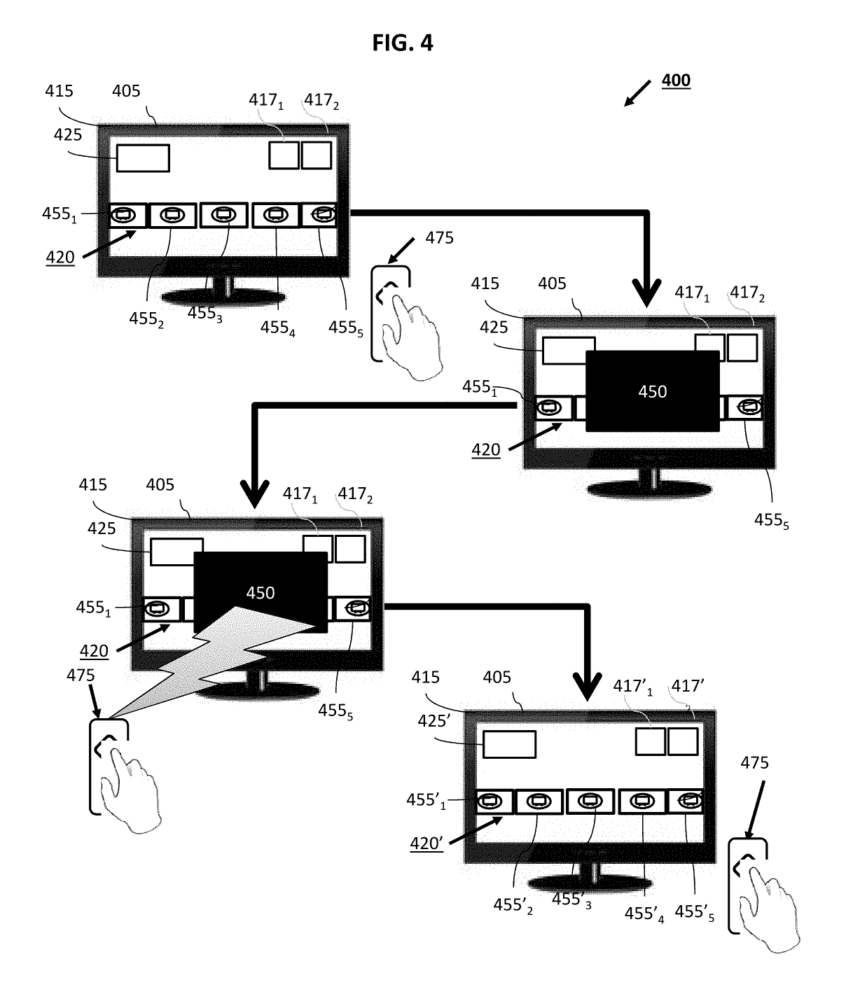

Turning to FIG. 4, a schematic overview of a system (e.g., system 300) and method 400 is described moving from an initial control interface 420 (similar to previously described interface 320) to a modified control interface 420′ controlled and/or personalized upon establishing the temporary connection between display 405 and peripheral device 475. The initial display presentation format of control interface 420 relates to one or more tile elements 455ₙ, such as TV shows, movies, games, etc. Upon detection of element 450, control interface 420 can be personalized, including elements 455′ₙ as they relate is provided, wherein one or more of elements 455′ₙ may be manually or automatically reformatted based on information detected upon scanning of element 450 by device 475.

The display device 405 can present, over control interface 420, a connection interface to establish a temporary connection between a peripheral device 475 and display 405. The connection interface may include a machine readable graphical element 450. Graphical element 450 is used to initiate a temporary connection between the display device 405 and a peripheral device 475, wherein element 450 be any graphical element that includes identifying information such as a serial number, a bar code, a QR code. Peripheral device 475 can be operable to detect and identify element 450 thereby establishing the temporary connection with display 405.

In another embodiment, detection of the machine readable graphical element 475 by the peripheral device 475 can include peripheral device 475 transmitting one or more commands or informational indications over a local network to display device 405, and/or any receiver component operatively coupled therewith. However, system 400 is not so limited and instead display device 405 can be communicatively coupled to device 475 across a remote network (e.g. a cellular network) and/or wirelessly connected, device-to-device, through radio waves (e.g. Bluetooth).

Upon establishing the temporary connection, peripheral device 475 can control display device, including by transmitting one or more commands to control interface 420 for presenting and updating content displayed thereon. In another embodiment, content from the peripheral device 475 is transmitted through the connection interface of the display device 405 by, for example, synchronizing the text keyboard of the peripheral device 475 with a text entry interface of the control interface 420 of the display device 405. For example, keying in a search term at the peripheral device 475 can cause that same keyed search term to be received by control interface 420 so that related content can be retrieved and presented on display device 405. In another embodiment, content from the peripheral device 475 can be transmitted and received by the display device 405 through the connection interface so that one or more tiles 455ₙ can be selectively positioned about the control interface 420 so that preferred or desirable content content or content sources are presented or arranged on display device 405. In another embodiment, content from the peripheral device 475 can be transmitted and received by the display device 405 through the connection interface by accessing or retrieving an application package directly from the display device for execution of one or more operations of system 400.

Additionally, display device 405, or another device such as a server (e.g. a cloud server) or other computing device operatively connected therewith, can host instructions for executing one or more of the steps associated with operations of system 400. In this embodiment, when the display device 405 receives content or other information from the peripheral device 475 through the connection interface, the display device 405 and updating, by the display device, the presentation format of the control interface to include the content includes controlling the display format of the display device through a web browser of the peripheral device and/or one or more settings of the control interface.

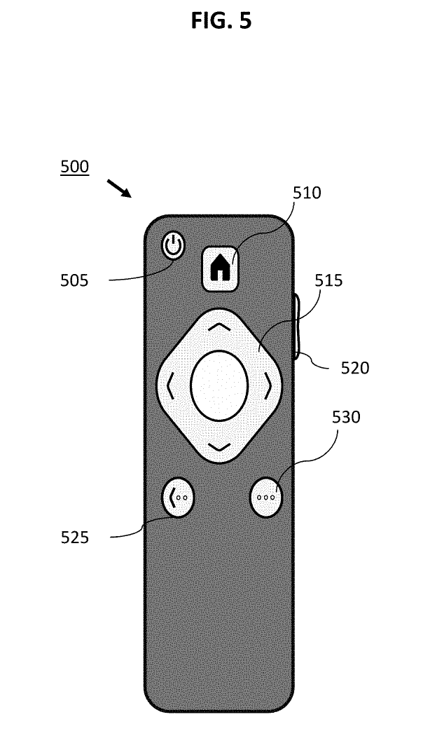

In some embodiments, device 475 may be a specialized control as shown in FIG. 5 (e.g. control 400) or may also be a computing device such as a smart phone, a tablet, desktop computer, laptop computer, workstation computer, gaming console, eReader, smart watch, wearable device, or the like, that is communicatively coupled to display device device 405. In another embodiment, device 475 can be transmit its number, identification, user account, chip information, or have its near field communication detected by device 405 when the temporary connection between devices 475 and 405 is established.

In another embodiment, one or more operations of system 400 can be advantageously supported by numerous versions of a given web-based software package used by browser-based clients. For example, embodiments can be implemented using a back-end component without hardware requirements for execution, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

System 400 is particularly advantageous for imparting a secure, quick, and instantly accessible interface for end-users to control display devices and access content and applications by connecting simply detecting a machine readable graphical element and establishing a temporary yet secure connection between the peripheral device 475 and the corresponding display device 405. This novel system 400 avoids having to preemptively modify peripheral device 475 with any specialized operations or software and instead, applications and operations of system 400 can be served, accessed, and executed directly from network-based services running on display device 405.

Additionally, upon establishing the temporary connection, the default profile 425 can be personalized to the end-user associated with peripheral device 475 so that profile 425 changes to profile 425′. Profile 425′ can include a personal dashboard control interface that relates to one or more user profiles stored by display device 405 for control interface 420. According to another embodiment, profile 425′ can include a dashboard component that allows for automatic detection and update of the user profile of peripheral device 475 as well as a graphical selection of multiple user profiles associated with peripheral device 475 that can define features of control interface 420. According to one embodiment, detection of element 450 launches profile 425′ and allows for presentation of a personalized control interface associated with a user profile. By way of example, display device is configured to allow a user to personalize the display format of the user interface to select display attributes such as a wallpaper, avatar, types of content tiles 455ₙ, etc. In that fashion, dashboard component of personalized profile 425′ allows for presentation of a personalized control interface. According to one embodiment, control interface 420 can allow for presentation of several user profiles 425′₁₋ₙ.

Turning to FIG. 5 is an exemplary remote control 500 to transmit commands to control interface (e.g. control interface 320, 420) by selectively engaging one or more of the plurality of graphical elements that may be selected and interacted using touch commands. In certain embodiments, remote control 500 includes power button 505 (to turn on and off a digital television), home 510, directional pad and select 515, back 525, menu 530, and volume up/volume down 520. According to one embodiment, remote control 500 may be employed to navigate and select elements of a control interface using directional pad and select 515. For example, select 515 may be operable to receive and distinguish between a plurality of different touch commands based on duration, force, whether touch is presently being sensed, or the like.

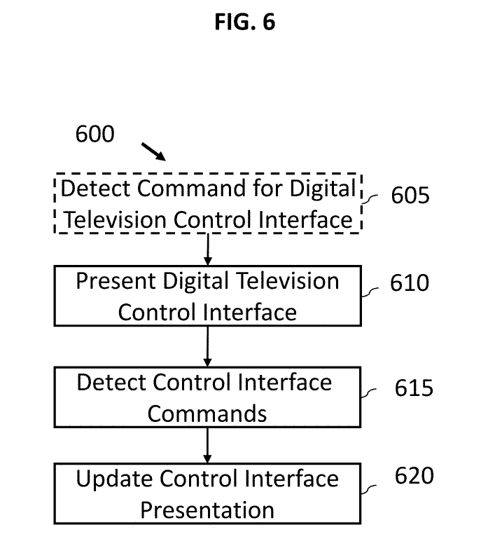

FIG. 6 depicts an exemplary process for control of a digital television according to one or more embodiments. Process 600 may be employed to for control and/or presentation of a control interface (e.g., interface 320, 420). Process 600 discusses, in part, operations of commands within a control interface (e.g., control interface 320, 420) and updating presentation of the control interface. According to another embodiment, control interface commands can produce presentation of other forms or configurations of control interfaces. By way of example, process 600 may be employed to presentation of a control interface of a digital television.

Process 600 may be initiated by presenting a control interface for a digital television at block 610 as content is being displayed to the television. For example, a clip, an episode, a movie, etc. may be in the process of being presented on the television. In one embodiment, the control interface is presented at block 610 to include an expanded tab element configured to provide a plurality of selectable elements associated with a category or other identifying criteria of the display content and being presented as an expanded tab element, and a plurality of tab elements configured in a navigable, horizontal bar configuration on a display of the digital television.

According to another embodiment, presenting the control interface at block 610 includes one or more graphical elements determined by the digital television based on one or more of a setup procedure and use of the digital television. By way of example, tab elements may relate to live or fluid graphical elements that may be updated based on use of the digital television, including any of the previously described criteria with respect to tile elements (e.g. elements 455ₙ of FIG. 4) as well as a user's previous selections, available content, personalization settings, etc. Thus, presentation of the control interface at a first point in time may include similar but different elements or configurations at a later point in time. By way of further example, in certain embodiments, one or both of the listing of tab elements and order of tab elements may remain the same, however presentation attributes of the tab elements and in particular graphical elements of the extended presentation format may be modified and updated by the digital television.

In certain embodiments, process 600 may optionally detect a command for a contextual control interface at block 605 prior to presentation of the interface at block 610. At block 615, the digital television detects a second command for the control interface to select one of the plurality of tab elements. According to another embodiment, selection of a tab element at block 605 relates to a navigational command to select a tab element, portion of a tab element, or navigation command in general with respect to the control interface. One or more control interface commands may be detected at block 615. According to one embodiment, control interface commands at block 615 relate to input commands for a control interface of the digital television configured as a hierarchical navigation pattern. In certain embodiments, selections of tab elements result in the digital television presenting one or more sheet views by the digital television. According to another embodiment, selections of tab elements results in launching a TV operation or application such as video on demand, a camera application, etc. At block 620, the digital television updates presentation of the control interface in response to the commands detected at block (e.g., second command). By way of example, the digital television can present a selected tab element with expanded configuration and/or provides a plurality of graphical elements.

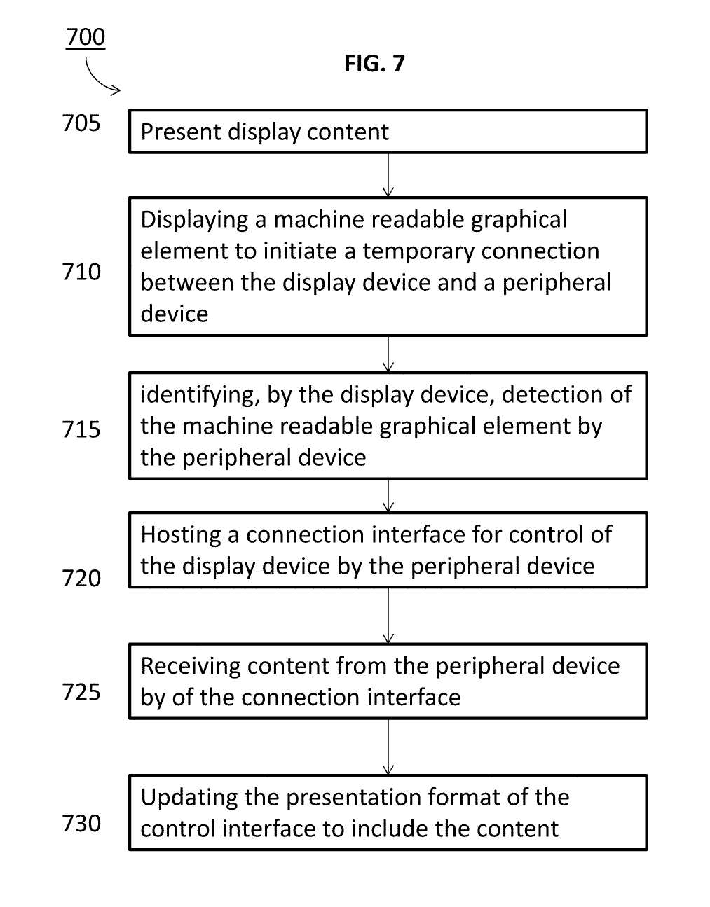

Turning to FIG. 7, a schematic overview of an operation 700 is depicted according to this disclosure. In step 705, display content is presented by a display device. In step 710, the display device displays a machine readable graphical element to initiate a temporary connection between the display device and a peripheral device. In step 715, the display device identifies detection of the machine readable graphical element by the peripheral device. In step 720, the display device hosts a connection interface for control of the display device by the peripheral device. In step 725, the display device receives content from the peripheral device by of the connection interface. In step 730, the display device updates the presentation format of the control interface to include the content.

While this disclosure has been particularly shown and described with references to exemplary embodiments thereof, it will be understood by those skilled in the art that various changes in form and details may be made therein without departing from the scope of the claimed embodiments.

What is claimed is:

1. A method of controlling a display device, the method comprising:
presenting, by the display device, a graphical representation of a control interface;
displaying, by the display device, a machine readable graphical element to initiate a temporary connection between the display device and a peripheral device;
identifying, by the display device, detection of the machine readable graphical element by the peripheral device;
hosting, by the display device, a connection interface for control of the display device by the peripheral device;
receiving, by the display device, content from the peripheral device through the connection interface; and
updating, by the display device, a presentation format of the control interface to include the content.

2. The method of claim 1, wherein presenting, by the display device, the graphical representation of the control interface includes presentation of a personal dashboard control interface.

3. The method of claim 1, wherein displaying, by the display device, the machine readable graphical element includes display of a QR code.

4. The method of claim 1, wherein identifying, by the display device, detection of the machine readable graphical element by the peripheral device includes receiving an indication from the peripheral device over a local network.

5. The method of claim 1, further comprising: hosting, by the display device or an application server communicatively coupled to the display device, instructions for executing the method, wherein receiving, by the display device, content from the peripheral device through the connection interface and updating, by the display device, the presentation format of the control interface to include the content includes controlling the display format of the display device through a web browser of the peripheral device and/or one or more settings of the control interface.

6. The method of claim 1, wherein receiving, by the display device, content from the peripheral device through the connection interface includes synchronizing a text keyboard of the peripheral device with a text entry interface of the control interface of the display device

7. The method of claim 1, wherein receiving, by the display device, content from the peripheral device through the connection interface includes selectively positioning one or more tiles of the control interface associated with content or content sources.

8. The method of claim 1, wherein identifying, by the display device, detection of the machine readable graphical element by the peripheral device is determined by identifying information of the peripheral device.

9. The method of claim 1, wherein receiving, by the display device, content from the peripheral device through the connection interface includes accessing or retrieving an application package for execution of the method directly from the display device

10. A system for controlling a display device:
the display device comprising:
a display configured to present a control interface; and
a processor coupled to the display, the processor configured to
present, by the display device, a graphical representation of a control interface;
display, by the display device, a machine readable graphical element to initiate a temporary connection between the display device and a peripheral device;
identify, by the display device, detection of the machine readable graphical element by the peripheral device;
host, by the display device, a connection interface for control of the display device by the peripheral device;
receive, by the display device, content from the peripheral device through the connection interface; and
update, by the display device, a presentation format of the control interface to include the content.

11. The system of claim 10, wherein the control interface includes presentation of a personal dashboard control interface.

12. The system of claim 10, wherein the machine readable graphical element includes display of a QR code.

13. The system of claim 10, wherein detecting of the machine readable graphical element by the peripheral device includes receiving an indication from the peripheral device over a local network.

14. The system of claim 10, the processor further configured to
host, by the display device or an application server communicatively coupled to the display device, instructions for executing operations of the processor,
wherein receiving, by the display device, content from the peripheral device of the connection interface and updating, by the display device, the presentation format of the control interface to include the content includes controlling the display format of the display device through a web browser of the peripheral device and/or one or more controlling settings of the control interface.

15. The system of claim 10, wherein receiving, by the display device, content from the peripheral device through the connection interface includes synchronizing a text keyboard of the peripheral device with a text entry interface of the control interface of the display device.

16. The system of claim 10, wherein receiving, by the display device, content from the peripheral device through the connection interface includes selectively positioning one or more tiles of the control interface associated with content or content sources.

17. The system of claim 10, wherein identifying, by the display device, detection of the machine readable graphical element by the peripheral device is determined by identifying information of the peripheral device.

18. The system of claim 10, wherein receiving, by the display device, content from the peripheral device through the connection interface includes accessing or retrieving an application package for execution of operations of the processor directly from the display device.
